(19) United States
(12) Patent Application Publication
(10) Pub. No.: US 2018/0299036 A1
(43) Pub. Date: Oct. 18, 2018

(54) HIGH STRENGTH DOWNHOLE TUBULARS AND METHODS FOR FORMING AND SYSTEMS FOR USING

(71) Applicant: Chevron U.S.A. Inc., San Ramon, CA (US)

(72) Inventors: Grzegorz J Kusinski, Houston, TX (US); Justin L. Cheney, Encinitas, CA (US)

(21) Appl. No.: 15/487,139

(22) Filed: Apr. 13, 2017

(51) Int. Cl. F16L 9/04; E21B 17/01; C22C 38/32; C22C 38/28; C22C 38/26; C22C 38/24; C22C 38/22; C22C 38/04; C22C 38/02; C23C 6/00; B23K 9/04; B23K 10/02; B23K 26/34; B23K 26/00; B23K 9/23

(52) U.S. Cl. CPC F16L 9/042; B23K 2201/04; C22C 38/32; C22C 38/28; C22C 38/26; C22C 38/24; C22C 38/22; C22C 38/04; C22C 38/02; C23C 6/00; B23K 9/048; B23K 10/027; B23K 26/34; B23K 26/0006; B23K 9/23; E21B 17/01

(57) ABSTRACT

Disclosed are high strength tubular devices for use in oil and gas well drilling and completions, oil and gas well intervention, and/or production systems. The high strength tubular devices include a pipe component and a secondary layer on the surface of the pipe component. The secondary layer can be either a continuous or partial layer and includes a nanostructured alloy. Alloy compositions are disclosed. Methods for forming the tubular devices are disclosed. The secondary layer can be formed on the pipe component by welding or casting. The tubular devices can be used in conductors, casing, drill pipe, production tubing, pipeline and risers.

### FIELD

The present disclosure relates to the field of tubulars and casings for use in a subsea environment, particularly for use downhole in oil and gas producing wells.

### BACKGROUND

Deepwater offshore oil and gas drilling operations must overcome particularly challenging environments. Temperatures and pressures have increased and tubing strings have become longer and heavier, necessitating advancements in downhole tubular technology, particularly providing tubulars having higher strength. Conventional tubing strings, production tubing, downhole tubular devices and well casings, referred to interchangeably herein as “tubulars,” are subject to the risk of collapse or other failure in high pressure formations. Using carbon steel pipe, a very thick pipe wall is required. This has a number of disadvantages including higher cost, higher weight and reduced bore diameter which has a negative impact on productivity. The only currently available sufficiently high strength alternatives to carbon steel are highly alloyed, highly expensive nickel alloys.

One promising technology area to meet the technical demands of tubulars for use in downhole applications is nanotechnology, known for drastically increasing strength in many materials including steel. However, the production techniques for bulk nanomaterials are not yet scalable to meet demand. While technically promising, utilizing bulk nanomaterials for downhole components remains cost prohibitive. Nanotechnology often describes the use of carefully fabricated nanostructured components that are not compatible with the weld process.

There exists a need for downhole tubulars which meet the above described technical demands in a more economical way.

### SUMMARY

In one aspect, a tubular device for use in drilling and/or production of a subterranean well is provided. The device includes a pipe formed of carbon steel or low alloy, and a secondary layer comprising a nanostructured alloy containing crystals having a crystal size of from 1 μm to 5 μm on the outer surface of the pipe.

In another aspect, a method for forming a downhole tubular device for use in a subterranean well is provided. The method includes welding or casting a secondary layer comprising a nanostructured alloy containing crystals having a crystal size of from 1 μm to 5 μm onto an outer surface of a pipe formed of carbon steel or low alloy.

In yet another aspect, a system for oil and gas drilling, completion, intervention and/or production including a subterranean well is provided. The system includes the above-described tubular device for use as at least one tubular component selected from the group consisting of a conductor within the well bore, a casing within the bore, a drill pipe extending at least partially into the bore, production tubing extending at least partially into the bore, pipeline in fluid communication with the subterranean well and a riser in fluid communication with the subterranean well.

### DESCRIPTION OF THE DRAWINGS

These and other objects, features and advantages of the present invention will become better understood with reference to the following description, appended claims and accompanying drawings. The drawings are not considered limiting of the scope of the appended claims. The elements shown in the drawings are not necessarily to scale. Reference numerals designate like or corresponding, but not necessarily identical, elements.

FIG. 1 is a simplified illustration of a device according to exemplary embodiments showing various patterns of the secondary layer on the pipe.

FIG. 2 is a simplified illustration of a system including the device according to exemplary embodiments.

### DETAILED DESCRIPTION

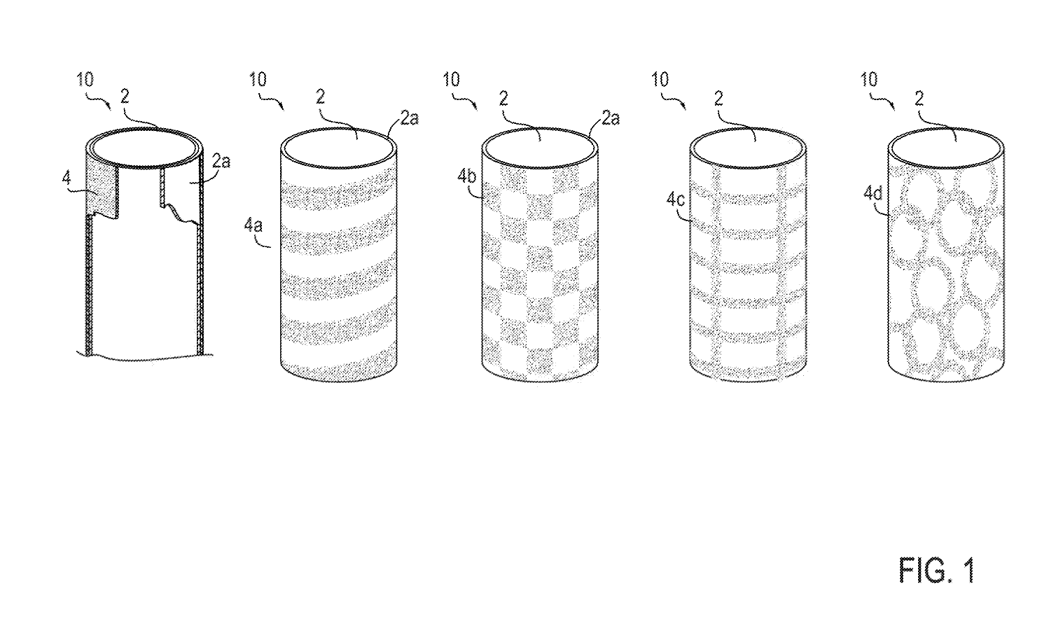

A tubular device for use in drilling and/or production of a subterranean well will be described with reference to FIG. 1. The device 10 includes a tubular element, also referred to herein as a pipe 2, and a secondary layer 4 on the outer surface 2a of the pipe 2.

In one embodiment, the pipe 2 is formed of iron, nickel, cobalt, or copper based alloy. In one embodiment, it is carbon (mild) steel. In one embodiment, the pipe 2 has an outer diameter of from 2 to 8 inches [KDGT1] (51 to 203 mm). In one embodiment, the pipe 2 has a wall thickness of from 0.2 to 0.5 inches (5.1 to 12.7 mm).

The secondary layer 4 on the pipe 2 is formed of a nanostructured alloy. The nanostructured alloy contains fine grains or crystals 6 having a crystal size of from 1 μm to 5 μm. In one embodiment, the nanostructured alloy contains crystals having no dimension greater than 10 μm.

In one nonlimiting embodiment, the nanostructured alloy has a composition containing from 0 to 6 atomic percent chromium, from 0 to 1 atomic percent manganese, from 4 to 6 atomic percent niobium, from 0.5 to 3 atomic percent vanadium, from 0 to 1 atomic percent carbon, from 1 to 3 atomic percent boron, from 0 to 0.25 atomic percent titanium, from 0 to 0.75 atomic percent silicon, at least one of molybdenum and tungsten at from 3 to 8 atomic percent each and from 0 to 15 atomic percent total, and a balance comprising iron and unavoidable impurities as trace elements. In one embodiment, the total concentration of the chromium and the niobium does not exceed 11 atomic percent. In one embodiment, the total concentration of the boron, the carbon and the silicon does not exceed 4 atomic percent. In one embodiment, nanostructured alloys containing at least 50 vol % martensitic phases are used. Such nanostructured alloys are advantageously resistant to cracking. In one embodiment, higher alloy materials resistant to corrosion in chloride or sulfide containing environments are used. Thermodynamic software can be used to model additional suitable nanostructured alloy compositions.

In one embodiment, the secondary layer 4 fully (i.e., continuously) covers the outer surface 2a of the pipe 2. In another embodiment, the secondary layer 4 partially covers the outer surface 2a of the pipe 2. The partial secondary layer 4 may have a pattern. For example, illustrated in FIG. 1 are a few nonlimiting possibilities. In one embodiment, the secondary layer 4 has a spiral pattern 4a. The pitch of the spiral pattern can be from _ to _ degrees. In one embodiment, the secondary layer 4 has a checkerboard pattern 4b. In one embodiment, the secondary layer 4 has a pattern 4c of crossing lines. In one embodiment, the secondary layer 4 has a pattern 4d of interconnecting shapes. Other patterns can be used. More than one pattern can be used.

In one embodiment, the secondary layer 4 has a thickness of from ⅛ in (3,175 mm) up to and including the wall thickness, even of from ⅛ in to ½ in (12.7 mm).

Advantageously, the tubular device 10 has a rupture strength that is higher than the rupture strength of the pipe 2 without the secondary layer 4. By rupture strength is meant herein the stress within the tubular device 10 just prior to yielding in a flexural test.

The secondary layer 4 can be a welded layer or a cast layer. In either case, a strong metallurgical bond exists between the pipe 2 and the secondary layer 4. In one embodiment prior to the deposition of the secondary layer 4, the pipe surface 2a is cleaned by any suitable technique to remove any paint, coatings, dirt, debris, and hydrocarbons. In one embodiment, the secondary layer 4 can be applied to the pipe 2 by welding a bead of the nanostructured alloy onto the outer surface 2a of the pipe 2. In one embodiment, the nanostructured alloy is formed into a stick electrode, e.g., a wire, of various diameters, e.g., 1-5 mm. The nanostructured alloy can be formed into a wire containing flux, which may allow for welding without a cover gas without porosity-forming in the weld deposit. The nanostructured alloy can be applied with mobile or fixed, semi or automatic welding equipment. In one embodiment, the nanostructured alloy is applied using any of laser welding, shielded metal arc welding (SMAW), stick welding, plasma transfer arc welding (PTAW), gas metal arc-welding (GMAW), metal inert gas welding (MIG), submerged arc welding (SAW), or open arc welding (OAW). In one embodiment, the outer surface 2a of the pipe 2 is first preheated at a temperature of 275° C. or greater, e.g., 275-500° C., for 0.01 hours to 100 hours. In one embodiment, the preheat may reduce or prevent cracking of the deposited welds.

In one embodiment, the secondary layer has the form of a spiral weld bead from 0.25 to 1.5 in (6.35 to 38.1 mm) wide. In one embodiment, the spiral weld bead is positioned on the outer surface of the pipe 2 such that adjacent passes of the spiral weld bead are spaced from 0.25 to 1.5 in apart from each other. The secondary layer 4 can be applied as a single layer, or as a plurality of layers.

In one embodiment, the secondary layer 4 can be applied to the pipe 2 by casting the nanostructured alloy onto the outer surface 2a of the pipe 2. In this embodiment, the pipe 2 is inserted into a mold and molten nanostructured alloy is poured into the mold to achieve the desired shape of the secondary layer 4.

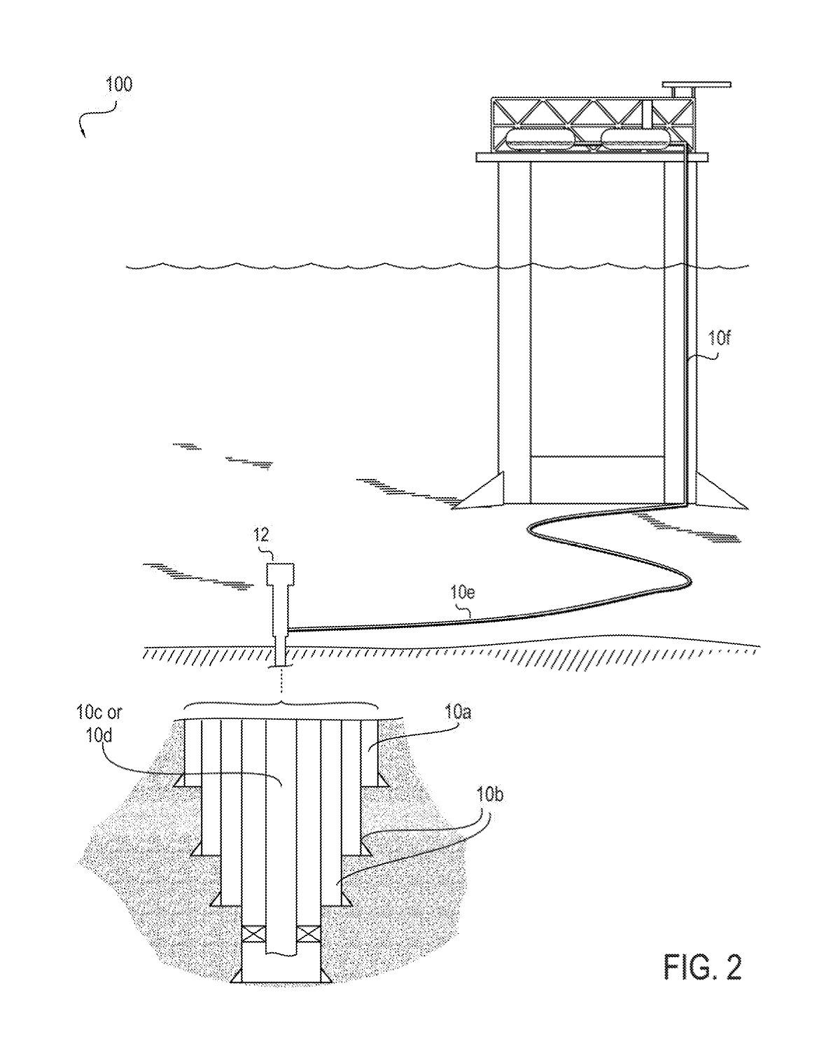

In one embodiment, the tubular device 10 is utilized in a system 100 including an oil and gas subterranean well 12. The system 100 can be a system for drilling, completion, intervention and/or production of the subterranean well 12 as described with reference to FIG. 2. The tubular device 10 can be employed as a tubular component in the system 100. For example, the tubular device 10 described herein can be used as a conductor 10a or a casing 10b within the well bore 12. By casing is meant a metal pipe or tube used as a lining for a water, oil, or gas well. Alternatively, or additionally, the tubular device 10 can be used as a drill pipe 10c extending at least partially into the bore 12 for conveying drilling fluid to a drill bit (not shown). The tubular device 10 can also be used as production tubing 10d extending at least partially into the bore 12 for conveying produced fluids from the well. The tubular device 10 can also be used as part of a pipeline 10e in fluid communication with the subterranean well 12. The tubular device 10 can also be used in a marine riser (or simply a riser) 10f in fluid communication with the subterranean well 12 for conveying produced fluids to a surface structure. In one embodiment, multiple tubular devices 10 can be connected in series. In one embodiment, multiple tubular devices 10 can be nested such that a tubular device 10 is positioned within another tubular device 10. For instance, this may be desired in particularly harsh environments, such as, but not limited to, extremely deep, high pressure environments, conveying produced fluids containing high levels of hydrogen sulfide.

In one embodiment, the tubular device 10 can be selectively employed in the system at specific locations of high stress and/or harsh environment.

The tubular device 10 disclosed herein advantageously increases the strength and structural integrity of tubulars used in drilling, completion, intervention and production systems. Such tubulars are thus resistant to wear, fatigue, collapse, stress corrosion, cracking

It should be noted that only the components relevant to the disclosure are shown in the figures, and that many other components normally associated with downhole tubulars are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be nonlimiting, such that recitation of items in a list is not to the exclusion of other like items that may also be useful in the materials, compositions, methods and systems of this invention.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

From the above description, those skilled in the art will perceive improvements, changes and modifications, which are intended to be covered by the appended claims.

What is claimed is:

1. A tubular device for use in drilling and/or production of a subterranean well, comprising:
a. a pipe formed of carbon steel or low alloy having an outer surface and a wall thickness; and
b. a secondary layer comprising a nanostructured alloy containing crystals having a crystal size of from 1 μm to 5 μm on the outer surface of the pipe.

2. The tubular device of claim 1 wherein the secondary layer is a welded layer or a cast layer.

3. The tubular device of claim 1 wherein the secondary layer partially covers the outer surface of the pipe.

4. The tubular device of claim 3 wherein the secondary layer has a pattern selected from the group consisting of a spiral pattern, a checker board pattern, a pattern of interconnecting shapes, a pattern of crossing lines and combinations thereof.

5. The tubular device of claim 1 wherein the secondary layer has a thickness from 3.175 mm to the wall thickness.

6. The tubular device of claim 1 wherein the secondary layer has a thickness from 3.175 mm to 12.7 mm.

7. The tubular device of claim 1 wherein the pipe has an outer diameter of from 51 mm to 203 mm.

8. The tubular device of claim 1 wherein the nanostructured alloy comprises from 0 to 6 atomic percent chromium, from 0 to 1 atomic percent manganese, from 4 to 6 atomic percent niobium, from 0.5 to 3 atomic percent vanadium, from 0 to 1 atomic percent carbon, from 1 to 3 atomic percent boron, from 0 to 0.25 atomic percent titanium, from 0 to 0.75 atomic percent silicon, at least one of molybdenum and tungsten at from 3 to 8 atomic percent each and from 0 to 15 atomic percent total, wherein a total concentration of the chromium and the niobium does not exceed 11 atomic percent, wherein a total concentration of the boron, the carbon and the silicon does not exceed 4 atomic percent, and a balance comprising iron and trace elements.

9. The tubular device of claim 1 wherein the nanostructured alloy comprises crystals having no dimension greater than 10 μm.

10. The tubular device of claim 1 wherein the tubular device has a rupture strength higher than the pipe of the tubular device without the secondary layer.

11. The tubular device of claim 1 wherein the secondary layer comprises a spiral weld bead from 6.35 to 38.1 mm wide.

12. The tubular device of claim 11 wherein the spiral weld bead is positioned on the outer surface of the pipe such that adjacent passes are spaced from 6.35 to 38.1 mm apart.

13. A method for forming a tubular device for use in drilling and/or production of a subterranean well, comprising:
a. welding or casting a secondary layer comprising a nanostructured alloy containing crystals having a crystal size of from 1 μm to 5 μm onto an outer surface of a pipe formed of carbon steel or low alloy and having a wall thickness.

14. The method of claim 13 wherein the secondary layer partially covers the outer surface of the pipe.

15. The method of claim 14 wherein the secondary layer has a pattern selected from the group consisting of a spiral pattern, a checker board pattern, a pattern of interconnecting shapes, a pattern of crossing lines and combinations thereof.

16. The method of claim 13 wherein the secondary layer has a thickness from 3.175 mm to the wall thickness.

17. The method of claim 13 wherein the secondary layer has a thickness from 3.175 mm to 12.7 mm.

18. The method of claim 13, wherein the nanostructured alloy comprises from 0 to 6 atomic percent chromium, from 0 to 1 atomic percent manganese, from 4 to 6 atomic percent niobium, from 0.5 to 3 atomic percent vanadium, from 0 to 1 atomic percent carbon, from 1 to 3 atomic percent boron, from 0 to 0.25 atomic percent titanium, from 0 to 0.75 atomic percent silicon, at least one of molybdenum and tungsten at from 3 to 8 atomic percent each and from 0 to 15 atomic percent total, wherein a total concentration of the chromium and the niobium does not exceed 11 atomic percent, wherein a total concentration of the boron, the carbon and the silicon does not exceed 4 atomic percent, and a balance comprising iron and trace elements.

19. An oil and gas drilling, completion, intervention and/or production system comprising:
a. a subterranean well comprising a bore within the earth; and
b. at least one tubular selected from the group consisting of a conductor within the bore, a casing within the bore, a drill pipe extending at least partially into the bore, production tubing extending at least partially into the bore, pipeline in fluid communication with the subterranean well and a riser in fluid communication with the subterranean well, wherein the at least one tubular comprises the tubular device of claim 1.

20. The system of claim 19, further comprising an additional tubular device of claim 1 within the at least one tubular device of claim 1.
